(19) United States
(12) Patent Application Publication
(10) Pub. No.: US 2023/0359280 A1
(43) Pub. Date: Nov. 9, 2023

(54) METHOD OF CUSTOMIZING HAND GESTURE

(71) Applicant: KAIKUTEK INC., TAIPEI CITY (TW)

(72) Inventors: MIKE CHUN-HUNG WANG, TAIPEI CITY (TW); GUAN-SIAN WU, TAICHUNG CITY (TW); CHIEH WU, HSINCHU CITY (TW); YU-FENG WU, ZHUBEI CITY (TW); WEI-CHI LI, TAINAN CITY (TW); TSUNG-MING TAI, TAICHUNG CITY (TW); WEN-JYI HWANG, TAIPEI CITY (TW); SIMON ANDREAS, TAIPEI CITY (TW); DELLA FITRAYANI BUDIONO, TAIPEI CITY (TW); FANG LI, NEW TAIPEI CITY (TW); CHING-CHIN KUO, Hsinchu City (TW)

(21) Appl. No.: 17/662,550

(22) Filed: May 9, 2022

(51) Int. Cl. G01S 15/58; G01S 15/89; G06F 3/01

(52) U.S. Cl. CPC G06F 3/017; G01S 15/58; G01S 15/89; G06F 3/011

(57) ABSTRACT

A method of customizing a hand gesture provides a touch screen, a computing unit connected with the touch screen, and a hand gesture database connected with the computing unit, and the method includes the following steps: recording a hand gesture trajectory data input of an input hand gesture on the touch screen; converting the hand gesture trajectory data input into a 2D trajectory graph of the input hand gesture; the computing unit sequentially reads a 2D hand gesture reference graph from the hand gesture database, and correspondingly generates a 2D hand gesture reference graph set for the 2D hand gesture reference graph read, and then the computing unit compares the similarity between the 2D trajectory graph of the input hand gesture and each reference graph in the 2D hand gesture reference graph set to determine whether the input hand gesture is already in the hand gesture database.

### BACKGROUND OF THE INVENTION

### 1. Field of the Invention

The present invention relates to adding new hand gestures, especially to a method of customizing a hand gesture.

### 2. Description of the Related Art

The detection and recognition of a user’s hand gestures is an alternative method of controlling electronic devices other than touch control and voice control. In recent years, the popularity of augmented reality (AR) and virtual reality (VR) has gradually made them popular human-computer interaction interfaces, and they have been applied to many fields such as games, tours, and medical care. Doppler radar has the advantages of fast response, fewer dead spots, and can be hidden when detecting and recognizing hand gestures. Therefore, Doppler radar has irreplaceable advantages in detecting and recognizing hand gestures.

In practical applications, a device with hand gesture motion detection and recognition functions, in addition to its own gesture motion detection and recognition technology, also needs to consider a problem that might be encountered when a user tries to create a customized hand gesture; because when the user creates a customized hand gesture, the user needs to repeat many times the hand gesture he/she wants to create, so as to record and mark the customized hand gesture, and at the same time, the device needs to be trained, resulting in a process flow of recording, marking and training the customized hand gesture. Often the process flow is tedious and uncertain, so the user of the device is likely to be stumped by said process flow of recording, marking and training, and thereby the user loses patience, and as a consequence the device with gesture motion detection and recognition functions is often not able to fulfill intended effects of said functions due to the problem of inconvenience in customizing a hand gesture.

Therefore, there is an urgent need for how to enable a device with motion gesture detection and recognition functions to add a customized hand gesture with minimal efforts from the user.

### SUMMARY OF THE INVENTION

In order to solve the above-mentioned problem, the present invention discloses a method of customizing a hand gesture, including the following steps:
S1: a touch screen recording a hand gesture trajectory data input of an input hand gesture;
S2: the touch screen converting the hand gesture trajectory data input into a 2D trajectory graph of the input hand gesture which is transmitted to a computing unit connected with the touch screen;
S3: the computing unit sequentially reading a 2D hand gesture reference graph from a hand gesture database connected with the computing unit, to determine whether the 2D hand gesture reference graph is successfully read, when the 2D hand gesture reference graph is not successfully read, the flow jumps to S6;
S4: the computing unit generating a 2D hand gesture reference graph set based on the 2D hand gesture reference graph being read;
S5: the computing unit comparing similarity between the 2D trajectory graph of the input hand gesture and reference graphs in the 2D hand gesture reference graph set, to determine whether the 2D trajectory graph of the input hand gesture is similar to the 2D hand gesture reference graph set; when any one of the reference graphs is successfully compared with the 2D trajectory graph of the input hand gesture in terms of similarity, then the 2D trajectory graph of the input hand gesture is similar to the 2D hand gesture reference graph set, the process flow ends; otherwise, the 2D trajectory graph of the input hand gesture is not similar to the 2D hand gesture reference graph set, the process flow jumps back to step S3;
S6: the computing unit writing the 2D trajectory graph of the input hand gesture into the hand gesture database as a newly added 2D hand gesture reference graph and giving the newly added 2D hand gesture reference graph a name, and the input hand gesture becoming a new hand gesture.

Preferably, each reference graph of the 2D trajectory graph of the input hand gesture and the 2D hand gesture reference graph set is a time series composed of multiple coordinate points on a preset two-dimensional XY coordinate plane.

Preferably, the similarity comparison between two time series is performed with a dynamic time warping (DTW) method.

### BRIEF DESCRIPTION OF THE DRAWINGS

FIG. 1 is a schematic diagram of an end device, a server and a cloud for executing the method of customizing a hand gesture of the present invention;

FIG. 2A is a schematic diagram of a new hand gesture trajectory data of the present invention;

FIG. 2B is a schematic diagram of a 2D new hand gesture trajectory graph of the present invention;

FIG. 2C is a composition of the 2D new hand gesture trajectory graph as shown in FIG. 2B with discrete position points;

FIG. 3 is a schematic diagram of a 2D hand gesture reference graph set of the present invention;

FIG. 4 is a flowchart of the method of customizing a hand gesture of the present invention; and

FIG. 5 is a flowchart of the test flow of a new gesture of the present invention.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

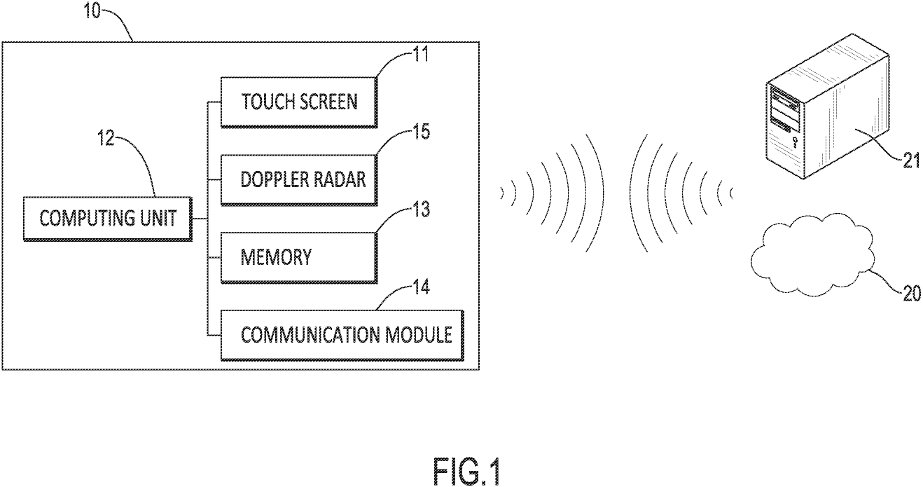

FIG. 1 shows an end device 10, a server 20, and a cloud 21 for performing a method of customizing a hand gesture of the present invention. The end device 10 includes a touch screen 11, a computing unit 12 connected with the touch screen 11, a memory 13 connected to the computing unit 12, a communication module 14 connected to the computing unit 12, and a Doppler radar 15 connected to the computing unit 12. The end device 10 is signal-connected to the server 20 and the cloud 21 through the communication module 14, such that, through proper configuration, the end device 10 can share information storage and computation tasks with the server 20 and the cloud 21. The end device 10 may be a mobile device, such as a mobile phone, a tablet computer or other devices with the above-mentioned functions.

The touch screen 11 can be a general two-dimensional (abbreviated as 2D herein) graphic touch input device; the computing unit 12 can be a system chip, such as a central processing unit (CPU) or a micro-controller; the memory 13 can be a solid-state memory or a disk drive; the communication module 14 is equipped with wired or wireless communication functions, such as: local area network (LAN), Wi-Fi, 2G/3G/4G/5G /6G, etc.; and the Doppler radar 15 has the function of detecting three-dimensional (abbreviated as 3D herein) gesture trajectories.

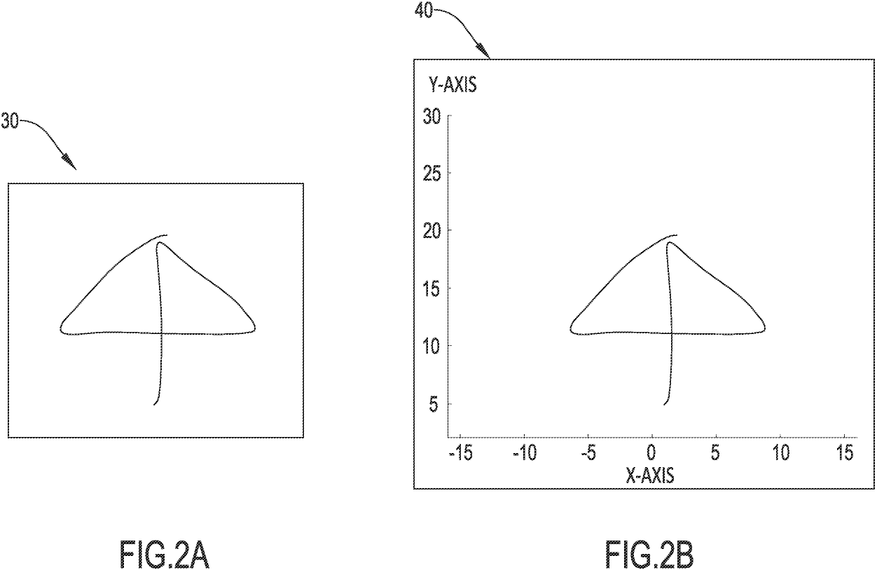

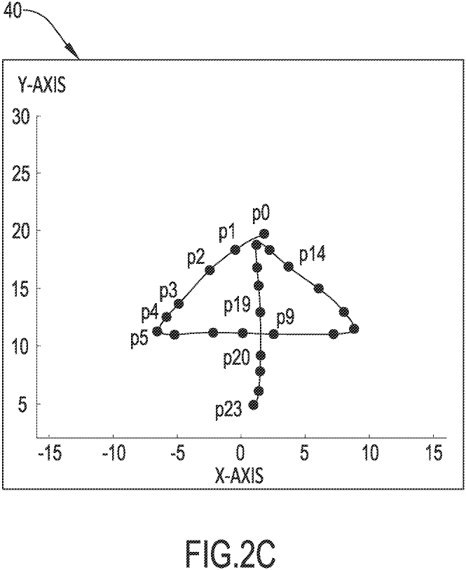

FIG. 2A shows a new hand gesture trajectory data input by the user. The user inputs a new hand gesture trajectory data 30 to the touch screen 11, and then the touch screen 11 transmits the new hand gesture trajectory data 30 to the computing unit 12. The new gesture trajectory data 30 is a time series composed of a plurality of position points of a gesture trajectory.

FIG. 2B shows a 2D trajectory graph of a new hand gesture. After receiving the new hand gesture trajectory data 30, the computing unit 12 converts the new hand gesture trajectory data 30 into a 2D new hand gesture trajectory graph 40.

FIG. 2C shows the composition of the 2D new hand gesture trajectory graph 40 in FIG. 2B. The 2D new hand gesture trajectory graph 40 is composed of, for example, position points P0-P23 (only some of the position points are marked in FIG. 2C ) which indicate that the new hand gesture input by the user moves sequentially from the position point P0, as the starting point, to the position point P23. These position points P0-P23 are one-to-one converted from corresponding position points of the plurality of position points in the new hand gesture trajectory data 30, wherein these position points P0-P23 are one-to-one corresponding to the coordinate points (X0, Y0)~(X23, Y23) and the time points t0~t23, that is, the coordinate point (X0, Y0) of the position point P0 is sampled at the time point t0, and the coordinate point (X1, Y1) of the position point P1 is sampled at the time point t1, and so on, and thereby these position points P0-P23 also constitute a time series, where these coordinate points (X0, Y0)~(X23, Y23) are coordinate points on a preset two-dimensional XY coordinate plane. When the position points P0-P23 are sampled at a fixed time interval, the distance between two adjacent points in the position points P0-P23 is proportional to the speed at which the user inputs the new gesture trajectory. It can be seen from the above that the 2D new hand gesture trajectory graph 40 is a time series composed of multiple coordinate points on the preset two-dimensional X-Y coordinate plane.

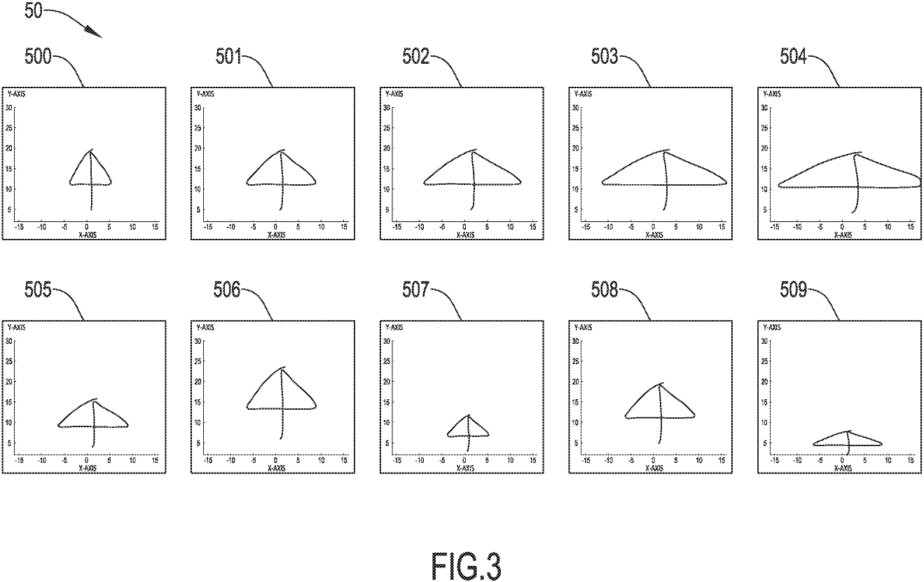

FIG. 3 shows a 2D hand gesture reference graph set. The 2D hand gesture reference graph set 50 is generated by a 2D hand gesture reference graph 500. The 2D hand gesture reference graph 500 is stored in a hand gesture database, and the 2D hand gesture reference graph 500 is one of the currently available 2D hand gestures stored in the hand gesture database. Those 2D hand gestures currently available in the hand gesture database are arranged in order. The 2D hand gesture reference graph 500 is also a time series consisting of multiple coordinate points on the preset two-dimensional XY coordinate plane.

The hand gesture database is stored in the memory 13. In one embodiment, the hand gesture database can also be stored in the server 20 or the cloud 21. The 2D hand gesture reference graph set 50 also has nine 2D hand gesture augmented reference graphs 501-509, and each of these 2D hand gesture augmented reference graphs 501-509 is generated by various deformations of the 2D hand gesture reference graph 500, for example, applying automatic deformation methods such as scaling, shifting, rotating, and random cropping to the 2D hand gesture reference graph 500 to produce these 2D hand gesture augmented reference graphs 501-509. Therefore, the 2D hand gesture reference graph set 50 is composed of the 2D hand gesture reference graph 500 and the 2D hand gesture augmented reference graphs 501-509. Each of the 2D hand gesture augmented reference graphs 501-509 is also a time series consisting of a plurality of coordinate points on the preset two-dimensional X-Y coordinate plane.

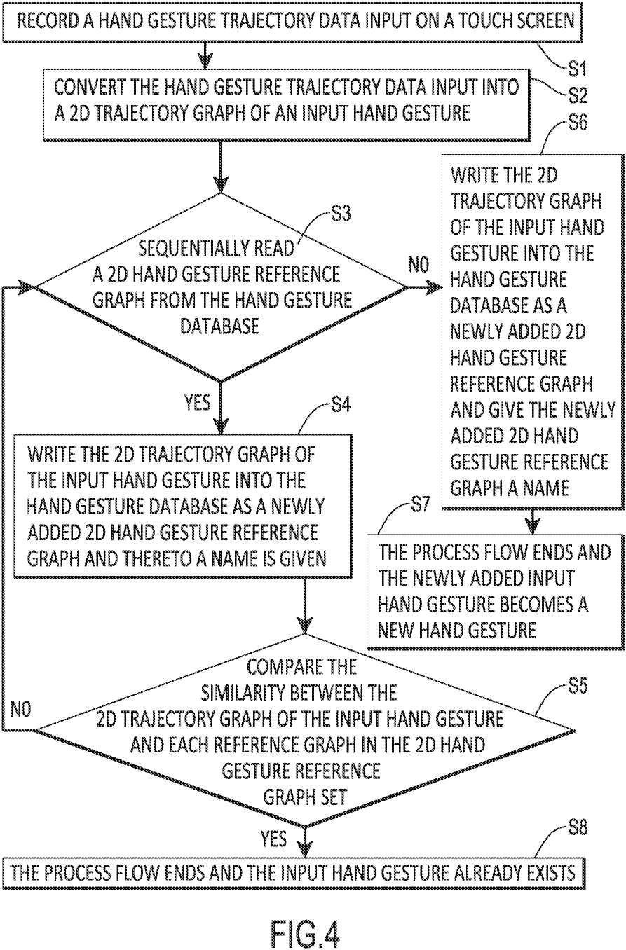

FIG. 4 shows the process flow of the method of customizing a hand gesture of the present invention. The process flow includes the following steps:
Step S1: Record a hand gesture trajectory data input on the touch screen 11.
Step S2: Convert the hand gesture trajectory data input into a 2D trajectory graph of an input hand gesture which is transmitted to the computing unit 12.
Step S3: The computing unit 12 sequentially reads a 2D hand gesture reference graph from the hand gesture database, if the 2D hand gesture reference graph can be read successfully, the flow jumps to step S4, and if the 2D hand gesture reference graph cannot be read, the flow jumps to step S6.
Step S4: The computing unit 12 generates a 2D hand gesture reference graph set based on the 2D hand gesture reference graph read.
Step S5: The computing unit 12 compares the similarity between the 2D trajectory graph of the input hand gesture and each reference graph in the 2D hand gesture reference graph set, to determine whether the 2D trajectory graph of the input hand gesture is similar to the 2D hand gesture reference graph set. If any one of the reference graphs is successfully compared with the 2D trajectory graph of the input hand gesture in terms of similarity, then the 2D trajectory graph of the input hand gesture is similar to the 2D hand gesture reference graph set, and the process flow jumps to step S8; otherwise, the 2D trajectory graph of the input hand gesture is not similar to the 2D hand gesture reference graph set, the process flow jumps back to step S3.
Step S6: Write the 2D trajectory graph of the input hand gesture into the hand gesture database as a newly added 2D hand gesture reference graph and give the newly added 2D hand gesture reference graph a name.
Step S7: The process flow ends, and the input hand gesture becomes a new hand gesture.
Step S8: The process ends, and the input hand gesture already exists.

Wherein, because existing 2D hand gestures stored in the hand gesture database are arranged in a sequence, in step S3, the flow is to sequentially read, one at a time from the hand gesture database, all the 2D hand gesture reference graphs corresponding to an existing 2D hand gesture in the hand gesture database, until all the 2D hand gesture reference graphs in the hand gesture database are completely read, and when there is no more 2D hand gesture reference graph to be read from the hand gesture database, the flow jumps to step S6.

In step S5, each reference graph in the 2D trajectory graph of the input hand gesture and the 2D hand gesture reference graph set is a time series composed of multiple coordinate points on the preset two-dimensional XY coordinate plane, accordingly, the dynamic time warping (DTW) method used in time series analysis can be used to carry out similarity comparison between two time series.

In step S6, because the hand gesture trajectory data input recorded in step S1 is not similar to all existing 2D hand gestures stored in the hand gesture database, the input hand gesture is indeed a new hand gesture, which must be given a name, and therewith the new hand gesture is written into the hand gesture database, thus completing the creation of the new hand gesture.

In step S8, since the gesture already exists, the hand gesture trajectory data input recorded in step S1, obviously, cannot be regarded as a new hand gesture.

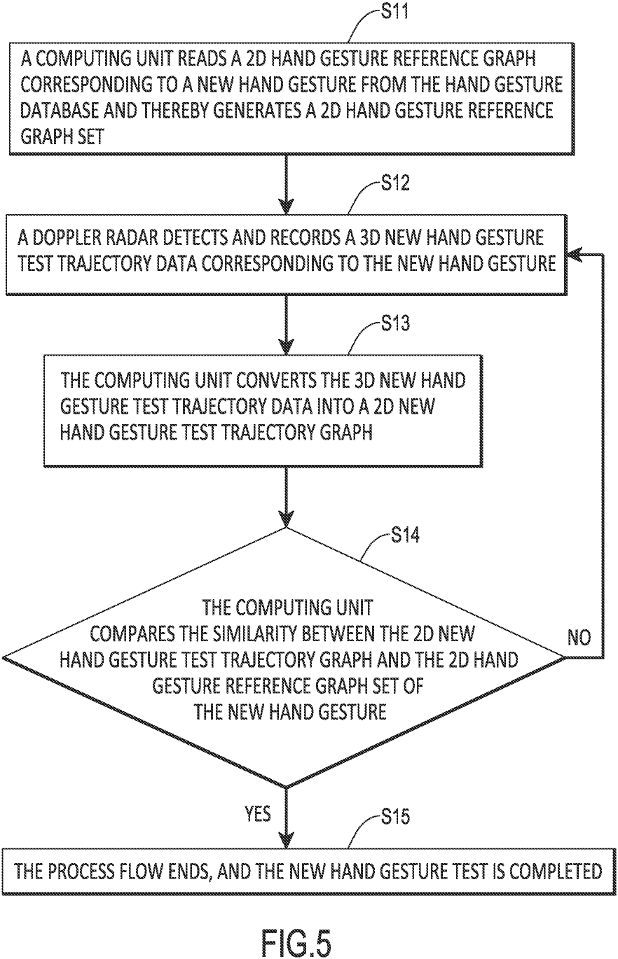

Please refer to FIG. 5. FIG. 5 shows the test flow of the new gesture created by the present invention. The test flow includes the following steps:
Step S11: the computing unit 12 reads a 2D hand gesture reference graph corresponding to the new hand gesture from the hand gesture database and thereby generates a 2D hand gesture reference graph set corresponding to the new hand gesture.
Step S12: the Doppler radar 15 detects and records a 3D new hand gesture test trajectory data corresponding to the new hand gesture, and transmits the 3D new hand gesture test trajectory data to the computing unit 12.
Step S13: the computing unit 12 converts the 3D new hand gesture test trajectory data into a 2D new hand gesture test trajectory graph.
Step S14: The computing unit 12 compares the similarity between the 2D new hand gesture test trajectory graph and the 2D hand gesture reference graph set of the new hand gesture, when the 2D new hand gesture test trajectory graph is not similar to the 2D hand gesture reference graph set of the new hand gesture, the flow returns to step S12.
Step S15: the process flow ends, and the new hand gesture test is completed.

Wherein, in order to test the 2D hand gesture reference graph of a new hand gesture which is stored in the hand gesture database, at first, in step S11, the computing unit 12 reads the 2D hand gesture reference graph of the new hand gesture from the hand gesture database, and thereby generates the 2D hand gesture reference graph set of the new hand gesture. Then the Doppler radar 15 detects and records a 3D new hand gesture test trajectory data of the new hand gesture performed by the user, and sends the 3D new hand gesture test trajectory data to the computing unit 12. Then the computing unit 12 converts the 3D new hand gesture test trajectory data into a 2D new hand gesture test trajectory graph, that is, a plurality of 3D position points of the 3D new hand gesture test trajectory of the 3D new hand gesture test trajectory data are projected one-to-one to corresponding coordinate points on a preset two-dimensional XY coordinate plane to generate the 2D new hand gesture test trajectory graph, accordingly the 2D new hand gesture test trajectory graph is a time series formed by a plurality of coordinate points on the preset two-dimensional XY coordinate plane. Then the computing unit 12 compares and determines whether the 2D new hand gesture test trajectory graph and the 2D hand gesture reference graph set of the new hand gesture are similar, and if they are not similar, the user needs to perform the new hand gesture again, and thereby the computing unit 12 compares and determines again whether the 2D new hand gesture test trajectory graph and the 2D hand gesture reference graph set of the new hand gesture are similar, until they are similar, and then the new hand gesture test is considered successful, and the test is ended.

In one embodiment, when a user performs a new hand gesture, there is no need for a precise starting point or a precise ending point, that is, a 3D new hand gesture test trajectory data collected by the Doppler radar 15, can be accumulated and expanded with time, and in the process of accumulating the 3D new hand gesture test trajectory data, as long as there is any period of time during which the 3D new hand gesture test trajectory data and the 2D hand gesture reference graph set of the new hand gesture are similar, it can be determined that the test of the new hand gesture performed by the user is successful.

Although the above disclosed process flows, test flows and embodiments of the present invention take the end device 10 performing main data processing and data storage as examples, both the server and the cloud connected with the end device 10 through networks are also capable of performing the functions of computation and data storage through proper configurations. Therefore, the execution device for data processing and data storage in the process flows, test flows and embodiments of the present invention is not limited to the end device 10.

The method of customizing a hand gesture disclosed by the present invention converts a hand gesture trajectory data input inputted through a touch screen into a 2D trajectory graph of an input hand gesture, which is then sequentially compared for the similarity with a 2D hand gesture reference graph set corresponding to each 2D hand gesture reference graph in the hand gesture database, so as to determine whether the hand gesture trajectory data input is a new hand gesture. When the hand gesture trajectory data input is determined to be a new hand gesture, the present invention further discloses a test flow to test the new hand gesture, so that after the new hand gesture is created, correctness and effectiveness of the new hand gesture can be further ensured.

Because the present invention discloses using the 2D hand gesture reference graph set to perform similarity comparison, when adding a new hand gesture, the user only needs to perform the input hand gesture once. In addition, because the present invention discloses that when testing a new hand gesture, and in the process of accumulating the test trajectory data of the new hand gesture, as long as there is any period of time during which the 3D new hand gesture test trajectory data and the 2D hand gesture reference graph set of the new hand gesture are similar, the test of the new hand gesture is successful. Therefore, when the user performs the new hand gesture, there is no need for a precise starting point and a precise ending point. Therefore, when testing a new hand gesture, a user can naturally perform the new hand gesture with ease, thereby greatly reducing time spent by the user when adding a new hand gesture to a device, and thus the purpose of the present invention can be achieved.

The aforementioned are preferred embodiments of the present invention. It should be noted that for those of ordinary skill in the art, without departing from the principles of the present invention, certain improvements and retouches of the present invention can still be made, which are nevertheless considered as within the protection scope of the present invention.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method of customizing a hand gesture, including the following steps:
S1: a touch screen recording a hand gesture trajectory data input of an input hand gesture;
S2: the touch screen converting the hand gesture trajectory data input into a 2D trajectory graph of the input hand gesture which is transmitted to a computing unit connected with the touch screen;
S3: the computing unit sequentially reading a 2D hand gesture reference graph from a hand gesture database connected with the computing unit, to determine whether the 2D hand gesture reference graph is readable, and when the 2D hand gesture reference graph is non-readable, the method jumps to S6;
S4: the computing unit generating a 2D hand gesture reference graph set based on the 2D hand gesture reference graph being read;
S5: the computing unit comparing similarity between the 2D trajectory graph of the input hand gesture and reference graphs in the 2D hand gesture reference graph set, to determine whether the 2D trajectory graph of the input hand gesture is similar to the 2D hand gesture reference graph set; when any one of the reference graphs is similar to the 2D trajectory graph of the input hand gesture, then the 2D trajectory graph of the input hand gesture is similar to the 2D hand gesture reference graph set, themethod ends; otherwise, the 2D trajectory graph of the input hand gesture is not similar to the 2D hand gesture reference graph set, the method jumps back to step S3; wherein, the similarity comparison between two time series is performed with a dynamic time warping (DTW) method;
S6: the computing unit writing the 2D trajectory graph of the input hand gesture into the hand gesture database as a newly added 2D hand gesture reference graph and giving the newly added 2D hand gesture reference graph a name, and the input hand gesture becoming a new hand gesture.

2. The method of customizing a hand gesture as claimed in claim 1, wherein, each reference graph of the 2D trajectory graph of the input hand gesture and the 2D hand gesture reference graph set is a time series composed of multiple coordinate points on a preset two-dimensional XY coordinate plane.

3. (canceled)

4. The method of customizing a hand gesture as claimed in claim 1, further including a test of the new hand gesture, including the following steps:
S11: the computing unit reading the 2D hand gesture reference graph corresponding to the new hand gesture from the hand gesture database and thereby generating a 2D hand gesture reference graph set corresponding to the new hand gesture;
S12: using a Doppler radar to detect and record a 3D new hand gesture test trajectory data corresponding to the new hand gesture, and transmitting the 3D new hand gesture test trajectory data to the computing unit;
S13: the computing unit converting the 3D new hand gesture test trajectory data into a 2D new hand gesture test trajectory graph;
S14: the computing unit comparing similarity between the 2D new hand gesture test trajectory graph and the 2D hand gesture reference graph set corresponding to the new hand gesture, wherein when the 2D new hand gesture test trajectory graph is not similar to the 2D hand gesture reference graph setcorresponding to the new hand gesture, the method returns to step S12.

5. The method of customizing a hand gesture as claimed in claim 4, wherein when the computing unit converts the 3D new hand gesture test trajectory data into the 2D new hand gesture test trajectory graph, the computing unit projects a plurality of 3D position points of the 3D new hand gesture test trajectory of the 3D new hand gesture test trajectory data, one-to-one, to corresponding coordinate points on a preset two-dimensional XY coordinate plane, to generate the 2D new hand gesture test trajectory graph.

6. The method of customizing a hand gesture as claimed in claim 4, wherein the 3D new hand gesture test trajectory data corresponding to the new hand gesture detected and recorded by the Doppler radar is generated through performing the new hand gesture, when the new hand gesture is being performed, the 3D new hand gesture test trajectory data detected and recorded by the Doppler radar is accumulated and expanded with time, and while accumulating the 3D new hand gesture test trajectory data, as long as there is any period of time during which the 3D new hand gesture test trajectory data and the 2D hand gesture reference graph set corresponding to the new hand gesture are similar, the test of the new hand gesture being performed is successful.
